(19) United States
(12) Patent Application Publication
(10) Pub. No.: US 2023/0257850 A1
(43) Pub. Date: Aug. 17, 2023

(54) Novel Systems And Methods Of Reductive-Acid Leaching Of Spent Battery Electrodes To Recover Valuable Materials

(71) Applicant: Garrison Minerals, LLC, Wheat Ridge, CO (US)

(72) Inventors: Michael Girard Irish, Couer D'Alene, ID (US); Boris Andreevich Chubukov, Westminster, CO (US); Mac Garrison Mccreless, Golden, CO (US); Aaron William Palumbo, Westminster, CO (US)

(21) Appl. No.: 18/014,257

(22) PCT Filed: Jul. 1, 2021
(86) PCT No.: PCT/US21/40203

§ 371 Date: Jan. 3, 2023

Related U.S. Application Data
(60) Provisional application No. 63/046,972, filed on Jul. 1, 2020.

(51) Int. Cl. C22B 3/08; C22B 26/12; C25C 1/08; C22B 3/44; C22B 3/00; H01M 10/54

(52) U.S. Cl. CPC C22B 3/08; C22B 26/12; C25C 1/08; C22B 3/44; C22B 23/043; C22B 23/0461; H01M 10/54

(57) ABSTRACT

The present invention describes systems and methods of a novel hydrometallurgical process to perform reductive-acid leaching and separation of constituent compounds from solid material generated from the electrodes of lithium-ion batteries, or other source material containing target high-value materials. The process method involves the initial reductive-acid leaching with sulfur dioxide and sulfuric acid of the source material which may be performed in a single or a multi-step embodiment. In a single-step embodiment, the reductive-acid leaching results in two outlet streams, a leachate solution and a bulk solid, such as graphite. In a two-step embodiment, a dilute reductive-acid leaching results in a lithium brine that may be bled as a product stream. The resulting liquor, or leachate, can be subjected to precipitation and oxidation steps to remove other compounds except, for example lithium, cobalt, and nickel. Electrowinning may then be used to separate and recover cobalt and nickel alloys among other high value compounds from a lithium brine.

### CROSS REFERENCE TO RELATED APPLICATIONS

This International PCT application claims the benefit of and priority to U.S. Provisional Application No. 63/046,972 filed Jul. 1, 2020, the specification, claims and drawings of which are incorporated herein by reference in their entirety.

### TECHNICAL FIELD

The present invention is directed to the chemical separation and recovery of valuable materials such as lithium (Li), cobalt (Co), nickel (Ni), manganese (Mn), and graphite from a resource material. In one preferred embodiment, the present invention relates to the separation and recovery of lithium, cobalt, nickel, manganese, and graphite from a resource material containing appreciable amounts of each such as electrode materials from lithium ion batteries. Other compounds, impurities, or constituents may be present during the generation of the resource material such as aluminum, copper, and plastic casings of lithium ion batteries.

### BACKGROUND

The separation and recovery of metals, metal compounds, graphite, and other valuable materials from end-of-life batteries, and especially lithium ion batteries, represents an opportunity in urban mining and supply chain circularity. Metals and metal compounds that are of particular interest include lithium, cobalt, nickel, manganese, aluminum, and copper. Graphite is also of interest. Upstream processing of lithium ion batteries often includes collection, deactivation, removal of casing materials, and shredding or attrition of the electrode materials. In many such processes, the resulting product is commonly known as black mass and is comprised of the cathode and anode materials having been mixed together.

Common cathode chemistries include lithium cobalt oxide (LCO), nickel-manganese-cobalt (NMC), nickel-cobalt-aluminum (NCA), lithium manganate (LMO), and others. Anodes are almost always graphite or silicon. Because it is difficult to separate end-of-life batteries by specific cathodic composition, black mass compositions can be highly variable. Therefore, a robust and adaptive process must be used to accommodate the ever-changing environment of battery chemistries.

Nearly all hydrometallurgical processing routes begin with an extractive step, also known as leaching. The cathodic materials are difficult to completely dissolve in acids in order to be separated from graphite. Many acids, configuration, and operating configurations have been attempted including sulfuric acid, hydrochloric acid, nitric acid, and others have been tried with limited success. Reductive-acid leaching has proven to be an effective method of leaching the cathodic materials. Reduction of the cathodic materials breaks the chemical bonds of the cathodic materials, for instance converting cobalt from cobalt (III) to cobalt (II). When reduced, the cathodic materials are more easily dissolved in acids. Reductive leaching is the simultaneous reduction of the cathodic materials and dissolution in acid.

Reductive leaching with sulfur dioxide (SO2), often in combination with sulfuric acid, has been shown to be effective on a variety of ores, including black mass, with extractions approaching 100% of cobalt, lithium, nickel, and manganese. A generalized unbalanced chemical reaction can be shown as:

LiNiₓMn_{y}Co_{z}O₂+H₂SO₄+SO₂=Li₂SO₄+(Niₓ, Co_{z}, Mn_{y})SO₄+H₂O

Where x, y, and z represent the blended molar compositions of nickel, manganese, and cobalt, respectively, within black mass which is comprised of various lithium ion battery chemistries. Once in solution, the metals can then be separated via filtration from the bulk solid, graphite. Other constituents such as aluminum and copper may also be present in the black mass and can also dissolve in solution. All non-carbon constituents may be present in solution as sulfates, sulfitdes, dithionates, or other acid-soluble compound.

Reductive leaching forms a solution, or a mother leachate with all of the desired constituents contained within and may also include undesired trace impurities. The concentrations of ions within the mother leachate are entirely dependent on the composition of the black mass. Therefore, any downstream processes used must be adaptable to varying composition. Many unit operations exist to separate and recover the individual constituents, including but not limited to solvent extraction, ion exchange, precipitation, crystallization, electrowinning, electrolysis, biological uptake, and others. The configuration of the process must present an economical route for recovery while accounting for variable black mass composition.

Electrowinning is the process of applying DC current across a cell in order to recover metal product. Electrowinning is well-established for nickel and cobalt to produce metal. Similarly, a metal alloy may be produced if both metals are present within the electrolyte. However, in order to run the electrowinning process effectively and efficiently for nickel and/or cobalt, impurities must be removed, and especially those that participate in the electrochemical reaction, such as manganese. Manganese, at high concentrations, fouls the anode and prevents functionality of the cell. Black mass contains an unusually high amount of manganese compared to processes that have previously used electrowinning as a means of recovering nickel and/or cobalt.

There is no known process method to perform reductive acid leaching in sequence with electrowinning with black mass material generated from end-of-life lithium ion batteries where manganese is present in high concentrations. Secondly, there are no reductive-acid leaching process methods that target zero-discharge. Thrice repeated, there are no multi-step reductive-acid leaching processes that target a lithium product and/or recycle stream as a preliminary extractive step. The use of electrowinning within the process of recovering valuable materials necessitates a major unit operation to remove manganese from solution. The use of multi-step reductive-acid leaching in sequence with manganese oxidation and electrowinning for a zero-discharge process method has not been shown in the art.

### SUMMARY OF THE INVENTION

The present invention describes systems and methods of a novel hydrometallurgical process to perform reductive-acid leaching and separation of constituent compounds from solid material generated from the electrodes of lithium-ion batteries, or other source material containing target high-value materials. The process method involves the initial reductive-acid leaching with sulfur dioxide and sulfuric acid of the source material which may be performed in a single or a multi-step embodiment. In a single-step embodiment, the reductive-acid leaching results in two outlet streams, a leachate solution and a bulk solid, such as graphite. In a two-step embodiment, a dilute reductive-acid leaching results in a lithium brine that may be bled as a product stream. The resulting liquor, or leachate, can be subjected to precipitation and oxidation steps to remove other compounds except, for example lithium, cobalt, and nickel. Electrowinning may then be used to separate and recover cobalt and nickel alloys among other high value compounds.

One aspect of the invention includes systems, methods, and compositions for the reductive-acid leaching of a metal containing source material such as spent battery source material containing lithium, cobalt, nickel, manganese or graphite. In one preferred embodiment, spent battery source material may include black mass derived from processed lithium-ion batteries, or alternatively the source material may be an ore, such as a cobalt containing ore, a nickel containing ore, or a manganese containing ore, or a combination of the same.

One aspect of the invention includes systems, methods, and compositions for the recovery of valuable materials from spent battery components in an acid-reduction reactor. In this embodiment, a first quantity of source material, and preferably black mass derived from processed lithium-ion batteries containing lithium, cobalt, nickel, manganese or graphite may be placed in an acid-reduction reactor where it undergoes reductive-acid leaching causing the production of: 1) a mother leachate containing a mixture of solubilized metals, and 2) a quantity of bulk solid material, such as graphite, which can be extracted for further processing or commercial use.

In another aspect of the invention, a first quantity of source material, and preferably black mass derived from processed lithium-ion batteries containing lithium, cobalt, nickel, manganese or graphite may be placed in an acid-reduction reactor where it undergoes reductive-acid leaching wherein a pH of at least 6 is maintained during the leaching process causing the production of a first lithium (Li) brine. This first Li brine may be recycled back through the acid-reduction reactor further concentrated it through additional rounds of reductive-acid leaching.

In another aspect of the invention, a first quantity of source material, and preferably black mass derived from processed lithium-ion batteries containing lithium, cobalt, nickel, manganese or graphite, may be placed in an acid-reduction reactor where it undergoes reductive-acid leaching by introduction of an acid solution which may include a solution of sulfur dioxide (SO2) and/or a solution of sulfuric acid (H₂SO₄), and/or an acid solution generated by a downstream electrowinning step. In one preferred aspect, an acid solution is introduced into the acid-reduction reactor until a pH of between 1-4 is achieved causing the metals in the source material, in this embodiment lithium (Li), cobalt (Co), nickel (Ni), and manganese (Mn) from the black mass, to be solubilized. In another preferred aspect, approximately 0.25-2 mole of SO2 may be introduced into the acid-reduction reactor for each mole of Co, Ni and Mn in the black mass.

In another aspect of the invention, the pH in the acid-reduction reactor, during or after addition of an acid solution, can be adjusted by: 1) recycling downstream produced metal hydroxides; 2) introducing an acid, such as a concentrated acid solution from the electrowinning step to decrease or maintain the pH in the acid-reduction reactor; or 3) introducing a base compound, such as NaOH, to increase or maintain the pH in the said acid-reduction reactor, or a combination of the same.

In another aspect of the invention the pH of the mother leachate can be increased, causing solubilized metals in the leachate to form metal hydroxides which can be precipitated and in some embodiments extracted for further commercial processing or recycled back into the system as a pH modifying base. In one preferred aspect, the pH of the mother leachate can be increased to between 4 and 7.

In another aspect of the invention, aqueous manganese (Mn) present in the leachate can be oxidized forming insoluble manganese dioxide (MnO₂) which can further be precipitated from the leachate for further commercial processing and commercial use. In one preferred aspect, aqueous manganese (Mn) present in the leachate can be oxidized by contacting the leachate with SO2 and oxygen (O₂) forming insoluble MnO₂. Preferably 1 mole of O₂ can be added per mole of aqueous Mn present in the leachate. The insoluble Mn remaining in the leachate after oxidation is preferably less than 2 g/l but not less than 0.5 g/l. Notably, the step of oxidizing aqueous Mn can occur upstream or downstream from the step of precipitating metal hydroxides from the leachate.

In another aspect of the invention, having precipitated out a desired quantity of metal hydroxides and MnO₂, the leachate may be subjected to electrowinning to extract a quantity of cobalt and nickel, and preferably a cobalt/nickel alloy. This may cobalt/nickel alloy may be extracted from an electrowinning cell as cathode product as described below for further commercial processing. In one preferred aspect, the pH of the leachate can be increased, for example through the additions of recycled metal hydroxides or a base, such as NaOH, prior to electrowinning. In this preferred aspect, the leachate can be increased to at least a pH of 5.

In another aspect, an anolyte and/or spent electrolyte from the electrowinning step can be recycled back into the acid-reduction reactor to facilitate leaching of the source material. In one preferred aspect, the electrowinning process may be performed by an electrowinning cell, and in a preferred embodiment, an electrowinning cell where a bag is configured to separate the anodes and cathodes to concentrate the acid generated at the anode, wherein the concentrated acid solution is recycled into said acid-reduction reactor. As noted above, the concentrated acid solution may be recycling into the acid-reduction reactor to facilitate leaching of the source material, which may preferably be a quantity of black mass.

In another aspect of the invention, cobalt, nickel and other trace metals remaining in the product of the electrowinning process, generally referred to as a leachate or solution, may be converted to hydroxides through increasing the pH of the solution and precipitating out as metal hydroxides. In one preferred embodiment, these metal hydroxides can be recycled back into the system as a pH modifying base.

In another aspect of the invention, a lithium (Li) bleed stream can be generated to extract a quantity of Li Brine from the bleed stream for further commercial processing. In preferred embodiments, a portion of the Li brine from the bleed stream can be recycled said back into the acid-reduction reactor with an additional quantity of source material, such as black mass, for additional rounds of reductive-acid leaching. In this preferred aspect the step of recycling Li brine back into the acid-reduction reactor with an additional quantity of black mass increases the pH of the Li brine precipitating any cobalt, nickel and other trace metals remaining in the Li Brine as hydroxides.

Another aspect of the invention includes systems, methods and compositions for extracting valuable materials, such as cobalt, nickel or manganese from a source material, such as black mass derived from processed lithium-ion batteries, or a cobalt containing ore, a nickel containing ore, and a manganese containing ore. In this preferred aspect, a cobalt and nickel present in a source material is converted, preferably through leaching, from a solid state into an ionic state by contacting the source material with SO₂ gas and sulfuric acid through an aqueous medium followed by q solid-liquid separation step to recover a liquor. Next, the pH of the liquor may be increased to between 3-6 to facilitate the precipitation of iron, aluminum, and copper impurities as hydroxides followed by a second solid-liquid separation to recover the liquor. Next, aqueous manganese may be oxidized to form to insoluble manganese dioxide which can be precipitated from the liquor. In this preferred aspect, aqueous manganese may be oxidized to form to insoluble manganese dioxide by one or more of the oxidant selected from the group consisting of: oxygen, air, SO₂, ozone, and potassium permanganate, or a combination of the same. Having removed a portion of the aqueous manganese, the remaining liquor may undergo electrowinning to allow extraction of the cobalt and nickel, preferably as a cobalt/nickel allow. Notably, the step of electrowinning is performed by an electrowinning cell, or an cell having an electrowinning anode bag configured separate their anodes and cathodes to concentrate the acid generated at the anode. Sulfuric acid generated by this process may be recycled into the above referenced leaching step.

In another aspect, the invention includes a two-step leaching process first removes lithium from a source material with a quantity of cobalt remaining in the solid state. The lithium material may be extracted from the liquor through solid-liquid separation with the remaining cobalt and nickel leached into solution. In this aspect, the cobalt and nickel leaching may, preferably leach at a pH below 3, and may more preferably include a reductive-acid leaching process.

Another aspect of the invention includes an initial dilute reductive-acid leaching step to selectively extract a portion of the lithium. This step facilitates the concentrating of lithium sulfate and is to be mixed with the final outlet stream where lithium is the sole remaining constituent. A second SO2 leaching step dissolves most of the remaining metals resulting in a high purity graphite.

Another aspect of the invention includes one or more precipitation reactions to remove undesired metals in the form of hydroxides, such as for example Aluminum (Al), Copper (Cu), and Iron (Fe) as potential marketable product. In one embodiment, SO2 and oxygen are used to oxidize the Mn and precipitating MnO₂ as marketable product while balancing pH with recycled nickel- and cobalt-hydroxide for selective precipitation, ensuring the removal of Mn from solution. Similarly, the presence of cerium, zinc, cadmium, among others, may precipitate additional processing methods for removal if detrimental levels report to the Ni/Co alloy. Oxidation of manganese is accomplished using an SO2/O₂ mixture.

In another aspect of the invention, after substantial removal of detrimental metals save for lithium, an electrowinning step can be applied to produce a high purity nickel-cobalt metal alloy. Electrowinning of these metals is a well-established industrial technique and employed here as a separation method. In this preferred embodiment, manganese levels are reduced to standard electrowing practice of less than 2 g/l in the inlet solution, recycle of hydroxides or other base like NaOH to ensure a pH greater than 2.5. Purities of the nickel-cobalt alloy in preliminary tests that did not include solution purification to remove Cu, Fe, Al and Mn were 97.3%. Demonstrating a need to remove these metals before plating. The resulting lithium brine, while not a standard marketable product on its own, can undergo conventional concentrating and purification techniques to produce a range of lithium-based products.

Additional aspects of the invention may become evident in light of the figures and disclosure provided below.

### BRIEF DESCRIPTION OF THE FIGURES

FIG. 1 displays the generalized process steps and resulting product streams in one embodiment thereof;

FIG. 2 displays a block diagram of a single reductive leaching step in one embodiment thereof;

FIG. 3 displays a block diagram of a two reductive leaching steps in one embodiment thereof; and

FIG. 4 displays a modified process where manganese is oxidized and removed prior to the formation and removal of other hydroxides in one embodiment thereof;

### DETAILED DESCRIPTION OF THE INVENTION

The present invention includes a variety of aspects, which may be combined in different ways. The following descriptions are provided to list elements and describe some of the embodiments of the present invention. These elements are listed with initial embodiments; however, it should be understood that they may be combined in any manner and in any number to create additional embodiments. The variously described examples and preferred embodiments should not be construed to limit the present invention to only the explicitly described systems, techniques, and applications. Further, this description should be understood to support and encompass descriptions and claims of all the various embodiments, systems, techniques, methods, devices, and applications with any number of the disclosed elements, with each element alone, and also with any and all various permutations and combinations of all elements in this or any subsequent applications.

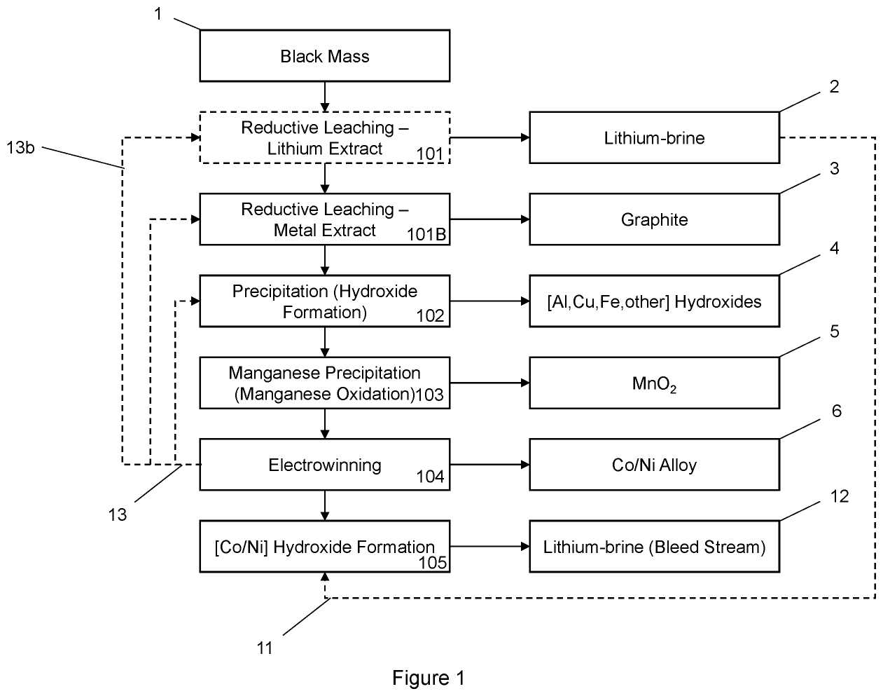

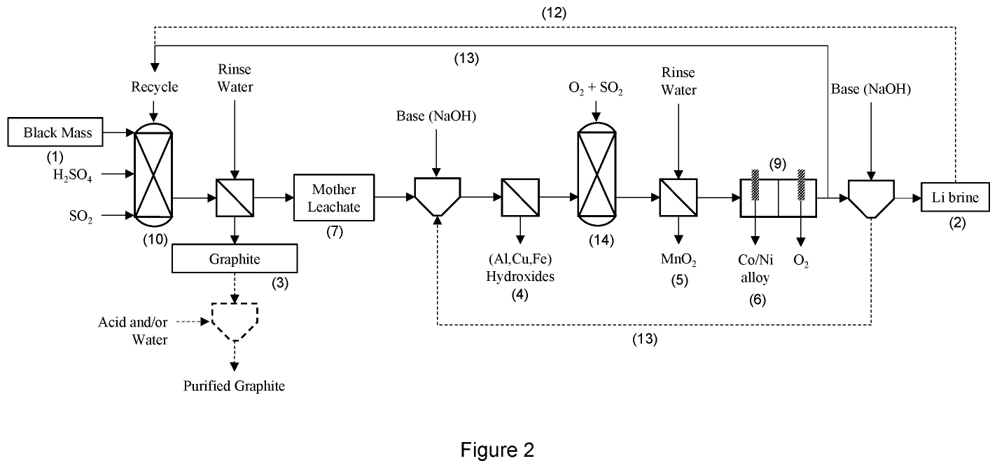

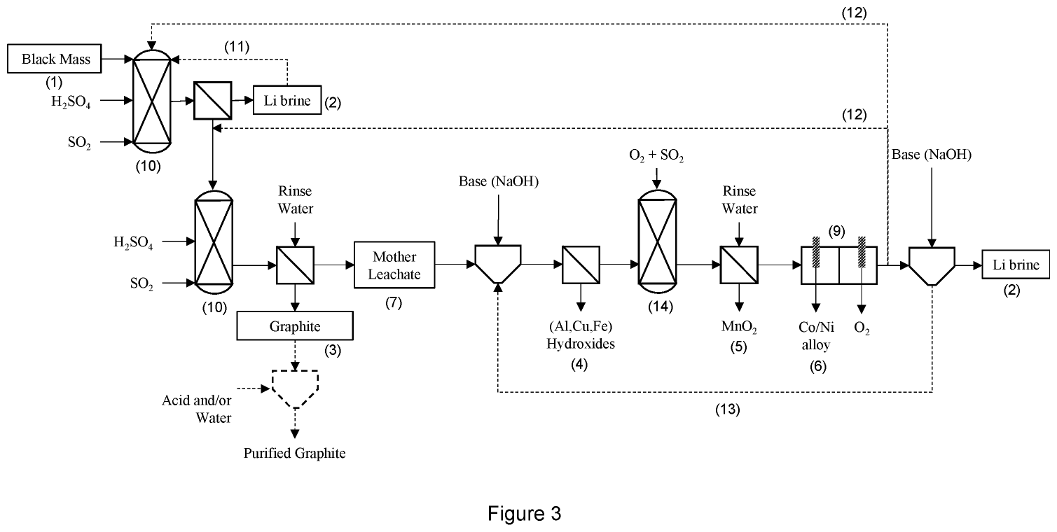

In one preferred embodiment, the invention includes novel systems and methods for the reductive-acid leaching and separation of constituent compounds from solid material generated from the electrodes of lithium-ion batteries (LIB). As shown generally in FIG. 1, in one embodiment the process method involves an initial reductive-acid leaching (101) step with sulfur dioxide and sulfuric acid of a black mass (1) solid which may be performed in a single (101) or a multi-step (101, 101A) embodiment. In a single-step embodiment shown in FIG. 2, the reductive-acid leaching (101) results in two outlet streams, a leachate solution (7) and a bulk solid such as graphite (3). In a two-step embodiment shown in FIG. 3, a dilute reductive-acid leaching (101) result results in a lithium brine (2) that may be bled as a product stream (12). The resulting liquor, or leachate (7), can be subjected to a precipitation (102) step, for example by the formation of hydroxides, and an oxidation (103) step, and preferably a manganese (Mn) oxidation step, to remove other compounds except lithium (Li), cobalt (Co), and nickel (Ni). Electrowinning (104) may then be used to separate and recover Co and Ni (6) from a Li brine. In this process, the acid produced in the electrowinning cell as may be used as primary acid source (13b) for the reductant/acid leaching of the Black Mass (1).

As noted above, the present invention includes a single and multiple-stage method for the reductive-acid leaching and separation of constituent compounds from solid material generated from the electrodes of lithium-ion batteries. In the first method shown in FIG. 2, single stage reductive-acid leaching (101) step occurs where Li, Co, Ni, and Mn are extracted at the same time. In a second method shown in FIG. 3, a portion of Li is selectively leached in one distinct step and then dissolved with the remaining Li, Co, Ni, Mn extracted in another step. As noted below, the invention include two methods to operate the electrowinning cell, namely a standard flow through cell and anode bags cell to produce a more concentrated acid stream (13b) that may be used as primary acid source for the reductant/acid leaching of the black mass (1).

### EXAMPLE 1: SINGLE STATE METAL EXTRACTION

As generally shown in FIGS. 1-2, in one preferred embodiment a quantity of black mass (1) is mixed with the acid solution (8), which may be the anolyte or electrolyte of the electrowinning (104) step generated from the electrowinning cell (9), and preferably a concentrated acid stream (13b) generated by the electrowinning (104) step generated from the electrowinning cell (9). As shown in FIG. 2, an acid solution is introduced into an acid-reduction reactor (10) until a pH of between 1-4 is achieved to solubilize the Li, Co, Mn, and Ni in the reactor.

In one embodiment, 0.25-2 mole of SO2 may be added to the acid-reduction reactor (10) for each mole of Co, Ni and Mn in the black mass (2). Preferably, the end pH when 0.25-2 mole of SO2 to 1 mole Co, Ni, Mn is added can be between approximately pH 1-4. If the pH drops below 2 upon the addition of 0.25-2 mole SO2, then a base, such as either recycle slurry of Co/Ni hydroxide, or NaOH can be added to hold pH at approximately 2 while remaining SO2 is added. This step may ensure enough reductant is added to the acid-reduction reactor (10) to dissolve the metals. If pH is greater than 4 when SO2 is at 0.25-2 mole SO2 per mole Co, Ni, Mn, then an acid, such as sulfuric acid can be added to the acid-reduction reactor (10) until a pH of approximately 3-4 is reached. This ensures sufficient acid is available to the system to dissolve the target metals.

### EXAMPLE 2: TWO-STAGE METAL EXTRACTION

In one preferred embodiment the invention includes a two-stage process for the reductive-acid leaching and separation of constituent compounds from solid material generated from the electrodes of lithium-ion batteries. As generally shown in FIGS. 1 and 3, in this two-stage process, a portion of Li, generally in the form a Lithium brine (2) is selectively leached from a first quantity of black mass (1) in one distinct step and then dissolved with the remaining Li, Co, Ni, Mn extracted in one or more separate step(s).

Referring again to FIG. 3, in this two-stage process a quantity of back mass (1) can be mixed with a hydroxide recycle stream (11) from this process in an acid-reduction reactor (10) while a small Lithium bleed stream (12) from the electrowinning loop can be used to control Li levels in the downstream electrowinning loop. SO2 is injected into an acid-reduction reactor (10) to pH of approximately 6 to facilitate the separation and extraction of Li present in the reactor, generally in the form of a Lithium brine (2). Moles of SO2 added to the acid-reduction reactor (10) are tracked and used in the calculation for stage 2 metals extract. Next, the pH is raised to approximately pH 9 to remove Co/Ni and other metals from Li product. The slurry is filtered and solids report to the second stage of the metal extraction process. The filtrate contains clean Li brine (2) for market. To optimize yields, the filtrate can be recycled back to acid-reduction reactor (10) and be mixed with a new quantity of black mass (1) to build Li concentration. The volume of the bleed stream (12) can be adjusted to maintain target product Li concentration.

Referring again to FIG. 3, solids from lithium brine (2), (also referred to as the Li extract) are mixed in an acid-reduction reactor (10) with the acid solution (13b) generated from the downstream electrowing process, and preferably a concentrated acid-solution (13b) from an anode bag used for electrowinning as described below. SO2 is injected until the combined SO2 from the Li extract (2) and this metals extract is approximately 0.25-2 mole SO2 to 1 mole Ni+Co+Mn. In this embodiment, the end pH when approximately 0.25-2 mole SO2 to 1 mole Co, Ni, Mn is added may be in the pH 1-4 range. If the pH drops below 2 upon the addition of 0.25-2 mole SO2, then a base, such as the recycled downstream slurry of Co/Ni hydroxide, or NaOH is added to hold pH at approximately 2 while remaining SO2 is added. This ensures enough reductant is added to dissolve the metals. If pH is greater than 4 when SO2 is at approximately 0.25-2 mole SO2 per mole Co, Ni, Mn then and acid, such as sulfuric acid is added until pH of approximately 3-4 is reached. This ensures enough acid is available to dissolve the target metals. The slurry produced is filtered and the extracted graphite (3) is washed prior to packaging. Next, the filtrate, generally referred to as the leachate (7) or mother leachate (7), undergoes a solution purification process.

### EXAMPLE 3: SOLUTION PURIFICATION

In one preferred embodiment, the invention may include the downstream precipitation and extraction of certain metals, such as Cu, Fe, and Al from the mother leachate (7). Generally referring to FIG. 2-3, the pH of the Leachate (7) is raised with NaOH or recycle hydroxides (13) to a pH of approximately 6. A target pH, whether 4 or as high as 7 can be determined once the Co/Ni concentrations are selected that optimize cathode quality in electrowinning cell. At 50 g/l Co/Ni optimum pH may be closer to 5.8. At 20 g/l Co/Ni the optimum pH may be around 6.1. Typically, 20-40 g/l range may be preferred and a pH of this step when optimized can be between approximately 5.9 to 6.1. Notably, the optimum pH is where most of the Cu, Fe, and Al are removed with minimal loses of Co/Ni. The solution is filtered with solids going to a Al precipitate wash step and remaining solution going to Manganese precipitation (103) step.

### EXAMPLE 4: MANGANESE PRECIPITATION

In one preferred embodiment, the invention may include the downstream precipitation and extraction of Mn (103), for example as a MnO₂ (5). Generally referring to FIG. 2-3, after the removal of metal hydroxides (4), the solution is transmitted to a Mn precipitation reactor (14), where SO2 and O₂ are added at published ratios to oxidize the Mn++ to its insoluble form of MnO₂. In this step, the process reduces the Mn levels to less than 2 g/l but not less than 0.5 g/l. The electrowinning cell (9) can tolerate this level of Mn and if all or most the Mn is converted to MnO₂ then the oxidant will start oxidizing Co++ to Co+++ and forming Co₂O₃ which is a loss of Co to the MnO₂ product.

Ignoring the O₂ that is added proportional to SO₂, in this embodiment 1 mole of SO₂ may be required to oxidize 1 mole Mn so the reaction is run at starvation levels of SO₂ to hit the target 1 g/l Mn in the finish solution. Though any level between 0.5 and 2 g/l can be used. Next, the pH is raised to approximately pH 5 with a base, such NaOH or recycled metal hydroxides (4) generated from the process. The leachate solution is filtered and solids go to a MnO₂ wash step while filtrate is passed to the electrowinning (104) step to further remove Co/Ni.

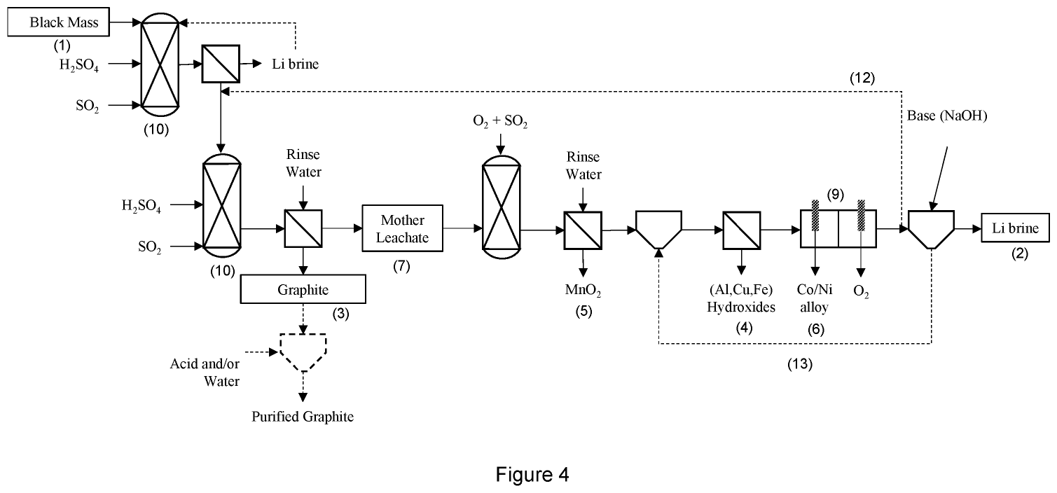

As noted in FIG. 4, the downstream precipitation and extraction of Mn (103), for example as a MnO₂ (5) can occur upstream prior to the formation and removal of other hydroxides (102).

### EXAMPLE 5: ELECTROWINNING

In one preferred embodiment, the invention may include a downstream electrowinning (104) step configured to remove certain additional metals, such as Co and Ni, for example as a Co/Ni alloy (6). As generally shown in FIGS. 2-3, as part of the single- or two-stage metal extraction process, the electrowinning (104) step may follow a standard flow through cell configuration, as opposed to an alternative anode bag. Using this operating design, the Co/Ni delta may need to be accounted for in the process. A standard operating design Co/Ni delta for a flow through cell is considered to be 5 g/l Co/Ni drop to maintain pH in the cell greater than 2.5 and more typically 3. The lower pH electrolyte can be recycled to the metals extract steps of the inventive process as an acid source (13b). With a flow through cell configuration, the metals extract step may be generally limited to 5 g/l Co/Ni delta.

In an alternative methods, the inventive process may utilize anode bags configured to perform the electrowinning (104) step. In this embodiment, the anode is surrounded by an anode bag. In one exemplary model, an anode bag produced by Filtaquip™ may be used as a representative device. From this anode bag anolyte can be recovered. Since acid is generated at the anode, the anolyte can contain 50 g/l sulfuric acid or more. In one embodiment, the process may utilize a general accepted anolyte strength of 50 g/l sulfuric acid which will then dissolve 30 g/l Co/Ni. This reduces the size of metal extract step by a factor of 6-30 g/l divided by 5 g/l for flow through cell.

### EXAMPLE 5: LITHIUM BLEED

In one preferred embodiment, the invention may include a lithium bleed stream (12) from the electrowinning loop to control Li levels in the downstream electrowinning loop. Since the metal extract and electrowing cell are in a closed loop, lithium may need to be removed so a bleed stream (12) that is at desired Li extract (2) concentration and at daily lithium production rate is removed each day. The pH can raise to pH 9 to precipitate contained metals. This stream is filtered with the filtrate being the daily lithium product (2) for market and the solids cobalt and nickel hydroxide being used as bases to be recycled back into the process as outlined above.

### TABLES

TABLE 1
Representative composition of black mass,
mother leachate, and product graphite

| Black Mass | Concentration | Extraction | Graphite Product |
|---|---|---|---|
| Constituent | [dry wt %] | Efficiency | Composition |
| Co | 15.8% | 99.92% | 0.023% |
| Li | 3.89% | 99.88% | 0.008% |
| Mn | 9.82% | 99.95% | 0.009% |
| Ni | 12.3% | 99.82% | 0.038% |
| Al | 0.29% | 84.21% | 0.079% |
| Cu | 0.14% | 60.17% | 0.094% |
| Fe | 0.38% | 96.80% | 0.021% |
| C(gr) | 57.0% | N/A | 99.66% |
| Others | 0.35% | 96.01%^{a} | 0.064% |

^{a}averaged extraction efficiency

TABLE 2
Representative composition of the solution after
removal of manganese, and other undesired products
as well as the solid manganese product.

| Constituent of Mn | Mn-lean Solution | Mn Product |
|---|---|---|
| Removal Step | [g/L] | [dry wt %] |
| Co | 46.667 | 0.005% |
| Li | 24.884 | 0.005% |
| Mn | 1.000 | 61.84%^{a} |
| Ni | 36.259 | 0.005% |
| Al | 0.000 | 0.00% |
| Cu | 0.0600 | 0.05% |
| Fe | 0.050 | 3.48% |
| Others | 1.611 | 0.00% |

^{a}balance is oxygen

TABLE 3
Representative composition of the solution in and out of the
electrowinning cell as well as the metal alloy product.

| Constituent of | EW Feed | EW Discharge | Ni/Co Product |
|---|---|---|---|
| EW Step | [g/L] | [g/L] | [dry wt %] |
| Co | 26.880 | 10.00 | 56.13% |
| Li | 24.884 | 24.88 | Trace |
| Mn | 1.000 | 1.00 | Trace |
| Ni | 20.890 | 7.70 | 43.61% |
| Al | 0.001 | 0.001 | Trace |
| Cu | 0.010 | 0.01 | Trae |
| Fe | 0.010 | 0.01 | Trace |
| Others | 1.611 | 1.52 | <0.25% |

1. A method of extracting metals comprising the steps:
depositing a first quantity of black mass derived from processed lithium-ion batteries in an acid-reduction reactor;
reductive-acid leaching said black mass through the introduction of an acid solution causing the production of:
a mother leachate containing a mixture of solubilized metals;
a quantity of bulk solid material;
increasing the pH of the mother leachate causing said solubilized metals to form metal hydroxides and further precipitating said metal hydroxides from the leachate;
oxidizing aqueous manganese (Mn) present in the leachate forming insoluble manganese dioxide (MnO₂) and precipitating said MnO₂ from the leachate;
electrowinning the leachate to form a quantity of cobalt/nickel alloy and extracting the cobalt/nickel alloy;
increasing the pH of the leachate precipitating cobalt, nickel and other trace metals remaining in the leachate as hydroxides;
generating a Lithium (Li) bleed stream; and
extracting said Li Brine from the bleed stream, or recycling said Li Brine back into said acid-reduction reactor with an additional quantity of black mass.

2-61. (canceled)

62. A method of extracting metal alloys from a source material comprising the steps:
depositing a first quantity of source material containing lithium, cobalt, nickel, manganese or graphite in an acid-reduction reactor;
reductive-acid leaching said source material through the introduction of an acid solution, wherein said acid-reduction reactor maintains a pH of at least 6, causing the production of a first Lithium (Li) brine to be further concentrated through additional application of reductive-acid leaching steps, and wherein said reductive-acid leaching said source material through the introduction of an acid solution causing the production of:
a mother leachate containing a mixture of solubilized metals;
a quantity of bulk solid material;
increasing the pH of the mother leachate causing said solubilized metals to form metal hydroxides and further precipitating said metal hydroxides from the leachate;
oxidizing aqueous manganese (Mn) present in the leachate forming insoluble manganese dioxide (MnO₂) and precipitating said MnO₂ from the leachate;
electrowinning the leachate to form a quantity of cobalt/nickel alloy and extracting the cobalt/nickel alloy;
increasing the pH of the leachate precipitating cobalt, nickel and other trace metals remaining in the leachate as hydroxides;
generating a Lithium (Li) bleed stream; and
extracting said Li Brine from the bleed stream, or recycling said Li Brine back into said acid-reduction reactor with an additional quantity of black mass.

63-65. (canceled)

66. A method of extracting metal from a feed material comprising the steps in order:
depositing a first quantity of nickel and/or cobalt rich feed material into an acid-reduction reactor;
reductive-acid leaching said feed through the introduction of an acid and reducing agent solution causing the production of:
a mother leachate containing a mixture of solubilized metals;
a quantity of bulk solid material;
increasing the pH of the mother leachate causing some of the impurity metals to form metal hydroxides and further separating said metal hydroxides from the leachate;
oxidizing aqueous manganese (Mn) present in the leachate forming insoluble manganese dioxide (MnO₂) and separating said MnO₂ from the leachate;
electrowinning the leachate to form a quantity of cobalt/nickel alloy and extracting the cobalt/nickel alloy;
increasing the pH of the leachate to precipitate and separate residual cobalt, nickel and other trace metals remaining from the leachate as hydroxides;
generating a lithium (Li) brine stream from the leachate

67. The method of claim 66, wherein said acid and reducing agent solution comprises a solution of sulfur dioxide (SO2) and/or a solution sulfuric acid (H₂SO₄), and/or an acid solution generated by said electrowinning step.

68. The method of claim 66, where the feed comprises black mass derived from lithium-ion batteries, a nickel or cobalt rich ore, a mixed hydroxide product (MHP), a raw or intermediate product containing nickel and/or cobalt, or a combination of the same.

69. The method of claim 66, wherein said solubilized metals are selected from the group consisting of: lithium (Li), cobalt (Co), nickel (Ni), and manganese (Mn).

70. The method of claim 67, wherein 0-2 mole of said SO2 is introduced into said acid-reduction reactor for each mole of Co, Ni and Mn in said feed.

71. The method of claim 66, wherein acid-reduction reactor maintains a pH between 1-4 during leaching.

72. The method of claim 66, further comprising the step of controlling the pH of the mother leachate by one or more of the following:
recycling downstream produced metal hydroxides to increase or maintain the pH in said acid-reduction reactor;
introducing a base compound to increase or maintain the pH in said acid-reduction reactor; and
introducing an acid compound to reduce the pH in said acid-reduction reactor; and
introducing an additional quantity of feed.

73. The method of claim 66, wherein said step of increasing the pH of the mother leachate compromises increasing the pH of the leachate to between 4-7.

74. The method of claim 66, wherein said step of oxidizing aqueous Mn is performed by an oxidant selected from the group consisting of: oxygen, air, SO₂, ozone, permanganate, or a combination of the same.

75. The method of claim 66, wherein the Mn remaining in said leachate after oxidation is less than 2 g/l but not less than 0.5 g/l.

76. The method of claim 66, wherein said step of oxidizing aqueous Mn occurs prior to the step of precipitating said metal hydroxides from the leachate.

77. The method of claim 66, wherein said step of electrowinning is performed in an electrowinning cell where a bag is configured to separate the anodes and cathodes to concentrate the acid generated at the anode, wherein the concentrated acid solution is recycled into said acid-reduction reactor.

78. The method of claim 66, wherein the stream is recycled back into the process to concentrate said solubilized metals or change the leachate pH.

79. The method of claim 66, further comprising a two-step reductive-acid leach of said feed, wherein said acid-reduction reactor maintains a pH of at least 6, causing selective leaching of lithium producing a second Li brine stream to be further concentrated through application of multiple reductive-acid leaching steps.

80. The method of claim 66, further comprising the step of increasing the pH of the Li brine to precipitate remaining cobalt, nickel and other trace metals as hydroxides.

81. The method of claim 66, wherein said quantity of bulk solid material comprises a quantity of graphite, silicon, and/or other non-solubilized material.

82. The method of claim 81, further comprising the step of purifying said quantity of graphite.
